(19) United States
(12) Patent Application Publication
(10) Pub. No.: US 2008/0073855 A1
(43) Pub. Date: Mar. 27, 2008

(54) Sleeve and housing assembly and method of adhesively bonding sleeve to housing

(76) Inventors: Richard Ivakitch, Toronto (CA); Philip Ridyard, Mississauga (CA); David Denis, Burlington (CA)

Correspondence Address: OGILVY RENAULT LLP (PWC), 1981 MCGILL COLLEGE AVENUE, SUITE 1600, MONTREAL, QC, H3A 2Y3, US

(21) Appl. No.: 11/513,302

(22) Filed: Aug. 31, 2006

(51) Int. Cl. F16J 15/447

(52) U.S. Cl. 277/415

(57) ABSTRACT

A sleeve mounting arrangement for use with a rotary component comprises a housing having a sleeve reception aperture defined along a rotation axis of the rotary component. The sleeve is positioned and retained within the housing by means of an adhesive provided in a pocket defined between the sleeve and the housing.

### TECHNICAL FIELD

The invention relates generally to a sleeve and housing assembly and, more particularly, to a sleeve and housing assembly suited for mounting an abradable seal runner into a surrounding housing.

### BACKGROUND OF THE ART

It is known in the art that mechanical parts which retain rotating elements tend to wear over time due to friction. This is especially true in the field of gas turbine engines where the rotating elements such as the high or low pressure turbine shafts rotate at a relatively high angular speed. For instance, labyrinth seals on high speed rotating shaft have a tight tip clearance with the surrounding seal runner. The relative rotation between the knife edges of the labyrinth seal and the seal runner can tend to cause rubbing wear on the runner surface. Such wear can significantly reduce the sealing capacity. Because of this predictable wear, it is common to provide the seal runner in the form a replaceable abradable sleeve. Hence, once the sleeve is worn past a predetermined threshold, the sleeve can be changed when the turbine engine is serviced.

To resist the high operating temperatures and high angular speeds of turbine engines, it is desired that the interconnection between the replaceable sleeve and the associated housing be robust, while allowing the sleeve to be removed from the housing during servicing. There remains a need in the art for improvements in the interconnection between sleeve and housing.

### SUMMARY OF THE INVENTION

It is therefore an aim of the invention to alleviate at least some of the needs in the field of replaceable sleeves.

In one aspect, the present invention provides an abradable sleeve mounting arrangement for use with a rotary component comprising: a housing having a sleeve reception aperture defined along a rotation axis of the rotary component; an abradable sleeve positioned and retained within the sleeve reception aperture, said abradable sleeve being adapted to receive a rotary component; a recess groove defined in at least one of the housing and the abradable sleeve, between the housing and the sleeve; and an adhesive in said recess groove, said adhesive bonding the abradable sleeve to the housing.

In a second aspect, the present invention provides a seal mounting arrangement for a rotating component, comprising a first tubular component having an inner surface circumscribing a first passage for coaxially receiving a tubular seal having an outer surface, the tubular seal defining a second passage for receiving the rotating component, the tubular seal being adhesively secured to the first tubular component by an adhesive provided in a gallery defined in at least one of the inner surface of the first tubular component and the outer surface of the tubular seal.

In a third aspect, the present invention provides a method of adhesively bonding a sleeve to a housing comprising: applying an adhesive compound in a recess groove provided in at least one of the housing and the sleeve; and inserting the sleeve in the housing for the applied adhesive to create an adhesive bond therebetween.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a schematic cross-sectional view of a gas turbine engine;

FIG. 2 is a cross-sectional view of a housing and sleeve assembly in accordance with one embodiment of the present invention;

FIG. 3 is a cross-sectional view of a housing and sleeve assembly in accordance with another embodiment of the present invention;

FIG. 4 is a cross-sectional view of a housing and sleeve assembly in accordance with another aspect of the present invention; and

FIG. 5 is a schematic view of method steps in accordance with an embodiment of the present invention.

### DETAILED DESCRIPTION OF THE PREFERRED EMBODIMENTS

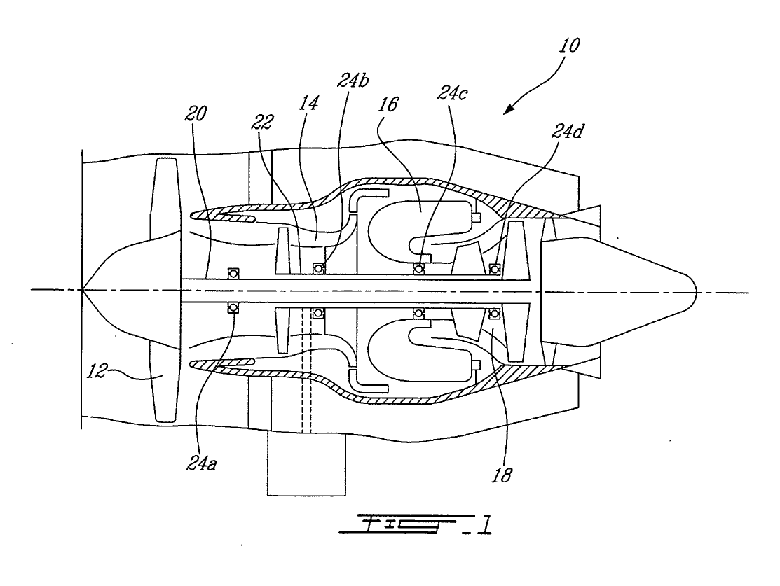

FIG. 1 illustrates a gas turbine engine 10 of a type preferably provided for use in subsonic flight, generally comprising in serial flow communication a fan 12 through which ambient air is propelled, a multistage compressor 14 for pressurizing the air, a combustor 16 in which the compressed air is mixed with fuel and ignited for generating an annular stream of hot combustion gases, and a turbine section 18 for extracting energy from the combustion gases. Typically, the low-pressure turbine shaft 20 and the high-pressure turbine shaft 22 are rotatably held within the gas turbine engine 10 via a plurality of bearings 24a, 24b, 24c and 24d. Each bearing has a sealing arrangement.

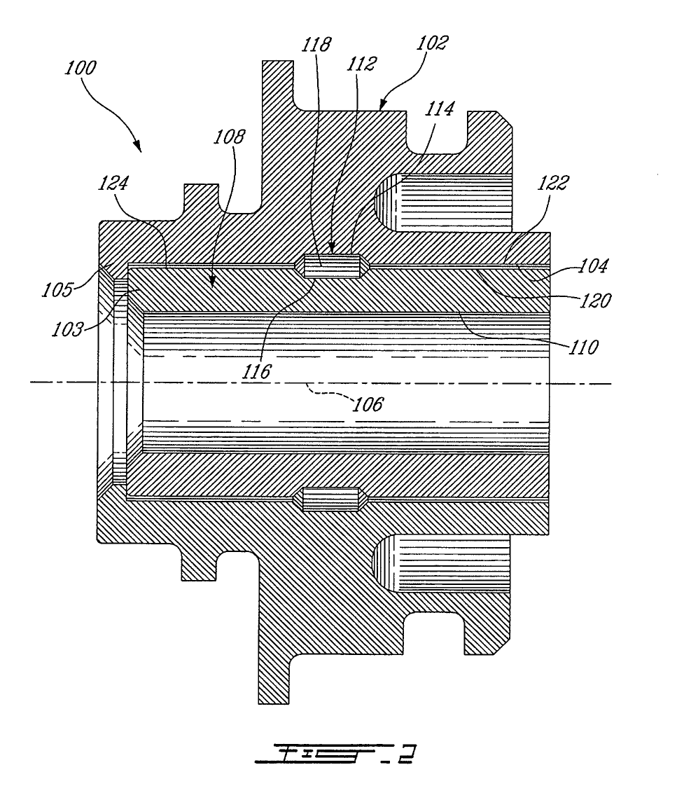

FIG. 2 illustrates an example of a sealing arrangement 100 suited for use as the bearing seal of bearing 24a (i.e. No. 1 bearing of the gas turbine engine). In this case, the bearing sealing arrangement 100 has a substantially regular surface of revolution shape, and therefore only one cross-sectional plane needs to be shown. The arrangement 100 includes a housing 102 which has an axially extending sleeve reception aperture 104. The sleeve reception aperture 104 is coaxial to a central rotation axis 106 of the engine. An abradable seal runner in the form of a sleeve 108 is positioned in the sleeve reception aperture 104, and an insertion end 103 of the sleeve 108 abuts against an optional stopper shoulder 105 of the housing once fully inserted therein. The sleeve 108 has a rotary element reception aperture 110 where the rotating shaft carrying (not shown) a labyrinth seal or the like is to be received.

A pocket or recess groove 112 is provided between the sleeve 108 and the housing 102. In this example, the recess groove 112 includes a housing recess groove 114 defined in the inner surface of the housing 102, and a sleeve recess groove 116 defined in the outer surface of the sleeve 108. Both the housing recess groove 114 and the sleeve recess groove 116 are defined at relative longitudinal positions in the housing 102 and the sleeve 108, respectively, which allow them to be axially aligned when the sleeve 108 is properly positioned in the housing 102. The grooves 114 and 116 extend all around the inner and outer circumferences of the housing 102 and the sleeve 108, respectively.

An adhesive 118 is provided in the recess groove 112 and bonds the sleeve 108 to the housing 102. Commercially available adhesives such as Loctite products 222, 242, 271, 290, 609, 620, 680 etc. could for instance be used. The type of adhesive used in the recess groove can be various and the selection of a particular type thereof will appear to those of skill in the art given the present disclosure. Once set, the adhesive 118 provides a solid permanently hardened biscuit that will prevent removal of the sleeve 108 from the housing 102 even if the bond between the sleeve and the housing fails. This design is less sensible to vibration and stress than conventional seal retention designs.

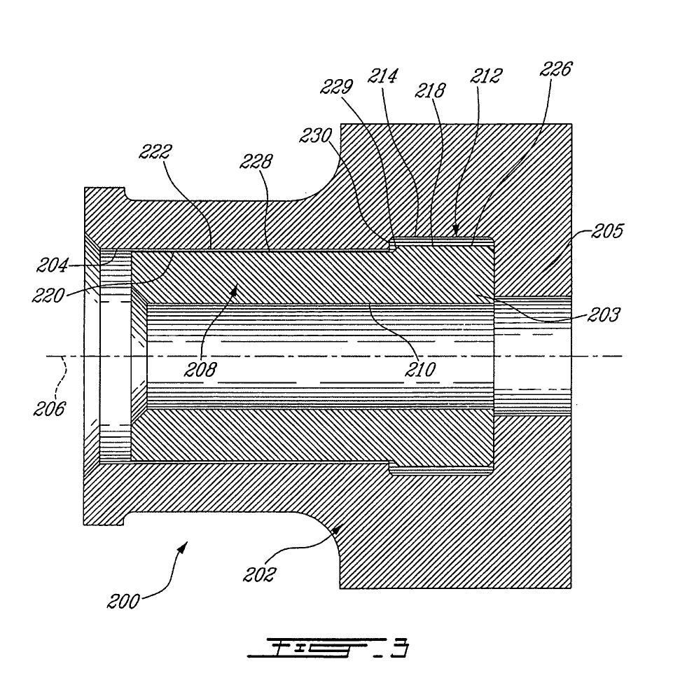

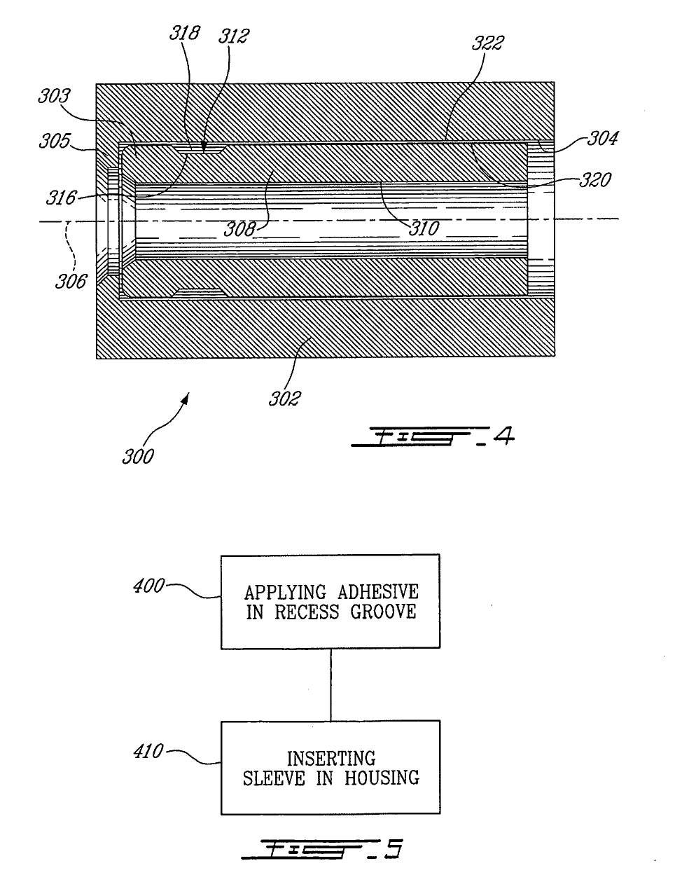

In alternate embodiments, the recess groove can be provided solely in the housing (such as depicted in FIG. 3), or solely in the sleeve (such as depicted in FIG. 4), instead of being provided in both.

Whether a recess groove 112 and its adhesive 118 are used or not, it is typically advantageous that a substantial portion of the outer surface 120 of the sleeve 108 be bonded to the inner surface 122 of the sleeve reception aperture 104. If an adhesive is to be used for this bond, it is typically advantageous that a loose fit be provided between the sleeve 108 and the housing 102 because a tight fit may result in any adhesive applied therebetween to be squeezed out upon assembly of the sleeve 108 with the housing 102. The use of a recess groove 112 therefore permits having a tight fit between the sleeve 108 and the housing 102 at all locations except where the recess groove 112 is located. Typically, the recess groove 112 extends only along a relatively small fraction of the overall length of the sleeve 108.

If a loose fit is used instead of a tight fit, an adhesive bond can be used between the sleeve outer surface 120 and the housing inner surface 122 in addition to the adhesive filling the recess groove 112. As mentioned hereinabove, one advantage which arises when the recess groove 112 is provided as two communicating recess grooves (114 and 116), is that the adhesive forms a hardened biscuit which provides retention even if the bond between the housing 102 and the sleeve 108 fails.

In the example of FIG. 2, it is contemplated that a loose fit can be used between the housing 102 and the sleeve 108, where an adhesive bond 124 can be used.

FIG. 3 will be described by way of comparison with FIG. 2 where corresponding elements have corresponding reference numbers in the two-hundred series. In the assembly 200 of FIG. 3, only one gallery or recess groove 212 is used: a housing recess groove 214. The housing recess groove 214 is provided in the inner surface of the housing at the end of the sleeve reception area 204, near the stopper shoulder 205. In this example, it is contemplated that a tight fit, such as an interference fit for example, can be used between the sleeve outer surface 220 and the housing inner surface 222. The adhesive 21 8 can be provided in the housing recess groove 214 prior to assembling the seal runner or sleeve 208 to the housing 202. The tight fit allows pre-machining of the sleeve 208 prior to installation, which is a lower cost alternative to machining the sleeve 208 after installation.

It will be noticed that the sleeve 208 in this example optionally has an interference neck 226 at the insertion end 203 thereof. The interference neck 226 is wider than the sleeve main body 228 and provides an additional safety in preventing the sleeve 208 from leaving the housing 202 by the interference neck edge 229 engaging the housing recess groove edge 230.

In FIG. 4, elements are given reference numbers in the three-hundred series. In this example, the recess groove 312 only has a sleeve recess groove 316.

FIG. 5 illustrates method steps of the present invention. In a first step 400, the adhesive is applied in a recess groove provided in the sleeve, the housing, or both. In a second step 410, the sleeve is inserted into the housing, and the adhesive creates a bond between the housing and the sleeve.

The above description is meant to be exemplary only, and one skilled in the art will recognize that changes may be made to the embodiments described without department from the scope of the invention disclosed. For example, various types of housings and sleeves of various dimensions can be used. Further, various positions, sizes and selections of recess grooves can be used. Still other modifications which fall within the scope of the present invention will be apparent to those skilled in the art, in light of a review of this disclosure, and such modifications are intended to fall within the appended claims.

What is claimed is:

1. An abradable sleeve mounting arrangement for use with a rotary component comprising:
a housing having a sleeve reception aperture defined along a rotation axis of the rotary component;
an abradable sleeve positioned and retained within the sleeve reception aperture, said abradable sleeve being adapted to receive a rotary component;
a recess groove defined in at least one of the housing and the abradable sleeve, between the housing and the sleeve; and
an adhesive in said recess groove, said adhesive bonding the abradable sleeve to the housing.

2. The sleeve mounting arrangement of claim 1 wherein there is a tight fit between the sleeve and the housing.

3. The sleeve mounting arrangement of claim 2 wherein the recess groove is defined solely in the housing.

4. The sleeve mounting arrangement of claim 3 wherein the sleeve further comprises an interference neck at a longitudinal position corresponding to a longitudinal position of the recess groove.

5. The sleeve mounting arrangement of claim 1 wherein there is a loose fit between the sleeve and the housing, and an additional adhesive in said loose fit which contributes in retaining the sleeve therein.

6. The sleeve mounting arrangement of claim 1 wherein the recess groove is defined at mating longitudinal positions of both the housing and the sleeve, and wherein the adhesive once set forms a hardened cookie adapted to prevent axial withdrawal of the sleeve from the housing in the event the bonds between the sleeve and the housing fails.

7. A seal mounting arrangement for a rotating component, comprising a first tubular component having an inner surface circumscribing a first passage for coaxially receiving a tubular seal having an outer surface, the tubular seal defining a second passage for receiving the rotating component, the tubular seal being adhesively secured to the first tubular component by an adhesive provided in a gallery defined in at least one of the inner surface of the first tubular component and the outer surface of the tubular seal.

8. The seal mounting arrangement of claim 7 wherein there is a tight fit between the tubular seal and the first tubular component.

9. The seal mounting arrangement of claim 7 wherein the gallery is defined solely in the inner surface of the first tubular component.

10. The seal mounting arrangement of claim 9 wherein the tubular seal further comprises an interference neck at a longitudinal position corresponding to a longitudinal position of the gallery.

11. The seal mounting arrangement of claim 7 wherein there is a loose fit between the tubular seal and the first tubular component, and an additional adhesive in said loose fit which contributes in retaining the tubular seal therein.

12. The seal mounting arrangement of claim 11 wherein the gallery comprises a pair of axially aligned recessed pockets respectively defined in the first tubular component and the tubular seal, and wherein the adhesive, once set, forms a hardened cookie adapted to prevent axial withdrawal of the tubular seal from the first tubular component in the event the bonds between the sleeve and the housing fails.

13. A method of adhesively bonding a sleeve to a housing comprising:
applying an adhesive compound in a recess groove provided in at least one of the housing and the sleeve; and
inserting the sleeve in the housing for the applied adhesive to create an adhesive bond therebetween.
